(19) United States
(12) Patent Application Publication
(10) Pub. No.: US 2005/0154843 A1
(43) Pub. Date: Jul. 14, 2005

(54) Method of managing a device for memorizing data organized in a queue, and associated device

(76) Inventors: Cesar Douady, Orsay (FR); Philippe Boucard, Le Chesnay (FR)

Correspondence Address: ERIC B. MEYERTONS;MEYERTONS, HOOD, KIVLIN, KOWERT & GOETZEL, P.C., P.O. BOX 398, AUSTIN, TX, 78767-0398, US

(21) Appl. No.: 11/008,410

(22) Filed: Dec. 9, 2004

(30) Foreign Application Priority Data
Dec. 9, 2003 (FR) FR 0314376

(51) Int. Cl. G06F 12/00

(52) U.S. Cl. 711/154

(57) ABSTRACT

Method of managing a device for memorizing data organized in a queue, in which, when the queue is empty of data and receives a data read request, the read request is memorized in the queue, instead of the data usually present when the queue is not empty of data, transforming the data queue into a read request queue.

### BACKGROUND OF THE INVENTION

1. Field of the Invention

The present invention concerns a method of managing a memorization device, in particular for data organized in a queue, and an associated device.

2. Description of the Relevant Art

Electronic systems require access to data necessary to the system, the system carrying out processes with these data. It is therefore necessary to have read and write access.

Interconnection networks are means of transmitting messages between various electronic or information technology agents, or communicating entities. A transmission can be made without carrying out any processing of the message, or by carrying out a processing of the message. In all cases, this is called the message transmission. Message processing is understood, for example, to be an analysis of data contained in the message, or an addition of data to the message.

A message is, of course, a succession of information technology data, that is to say a succession of bits or of bytes arranged with specific semantics, and representing a complete single element of information. Each message includes a message header which mainly includes the destination address of the message and the size of the message. A message is either a request sent by an agent initiating messages or a response sent by an agent that is the intended recipient or target of messages.

An ideal interconnection network would certainly be a fully interconnected network, that is to say a network in which each pair of agents is connected by a point-to-point link. That is however unrealistic, because it is too complicated when the number of agents exceeds a few tens. It is therefore desirable that the interconnection network be capable of carrying out all the communications between agents with a limited number of links per agent.

In a point-to-point interconnection network, one input of an agent is connected at most to one agent initiating messages or at most to one agent transmitting messages.

Interconnection networks include transmission devices or routers (“switches”), a network organization providing the link between the routers and the other agents, and a routing assembly which ensures the circulation of messages within the network organization.

A router is an active agent of the interconnection network that receives at its input messages coming from one or more agents and which transfers or routes each of these messages respectively to their destination agent or to another router. This routing is carried out by means of the address of the agent that is to receive the message, or the target agent, which is present in the header of the message to be routed.

The organization of a network consists in the physical structure connecting the different nodes or connection points of an interconnection network.

The routing assembly manages the manner in which a message is routed, or transferred, from a source agent sending the message to a target agent via routers using a routing path.

In an interconnection system, a memory organized as a queue or FIFO (“First In, First Out”), may occasionally be empty of data, while a request asks to read data in that queue.

In conventional manner, such a situation is treated in two different ways; either the request is blocking, or an error or subsequent test message is sent in response to the agent sending the read request. These methods may cause a momentary blockage of the system or unnecessarily use bandwidth.

### SUMMARY OF THE INVENTION

In light of the foregoing, it is desirable to improve the processing of the case in which the queue is empty of data and a read request requests data from this queue. One object is therefore to avoid blockages of the system or unnecessary use of bandwidth when this situation occurs.

In one embodiment, a method of managing a device for memorizing data organized in a queue is described. When the said queue is empty of data and the said memorization device receives a data read request, the said read request is memorized in the said queue, instead of the data usually present when the queue is not empty of data, transforming the data queue into a read request queue. The system is not blocked or unnecessary bandwidth is not used in order to respond with a message to the agent initiating the read request.

In an embodiment, when the queue includes at least one read request, the receipt of a new read request causes the said new read request to be memorized in the said read request queue.

In an embodiment, when the queue includes at least one read request, received data are directly transmitted to the agents that have sent the said read requests, and the expected quantity of data included in the said read requests is updated.

In an embodiment, when the queue includes at least one read request, the receipt of a quantity of data smaller than the quantity of data requested by the first read request of the read request queue causes the said data to be stored in an auxiliary memorization means, awaiting a later arrival of data to be memorized in the said auxiliary memorization means. Such storage is carried out until the quantity of data stored in the auxiliary memorization means is greater than or equal to the quantity of data required by the said first read request of the said read request queue.

In an embodiment, when the queue includes at least one read request and the first read request of the said read request queue is satisfied, the said first read request is deleted from the read request queue.

In an embodiment, when the said read request queue becomes empty of requests and data are received, the said data are stored in the said empty queue which becomes a data queue. In other words, the method is reversible.

According to another embodiment, a further proposal is for a device for memorizing data organized in a queue. The device includes a management means which, when the said queue is empty of data and the said device receives a data read request, is capable of memorizing the said read request in the said queue, transforming the data queue into a read request queue.

In an embodiment, the said management means is capable of memorizing a newly received read request in the said read request queue, when the queue includes at least one read request.

In an embodiment, the queue including at least one read request, the said management means is capable of transmitting received data directly to the agent that has sent the first read request of the queue and of updating the required quantity of data included in the said read request.

In a preferred embodiment, the queue including at least one read request, the said device includes an auxiliary memorization means capable of storing a quantity of received data smaller than the quantity of data required by the first read request of the queue.

In an embodiment, the said management means is capable of deleting the first read request from the said read request queue when the queue includes at least one read request and the first read request of the said read request queue is satisfied.

### BRIEF DESCRIPTION OF THE DRAWINGS

Other objects, features and advantages of the invention will appear on reading the following description, given as a non-limiting example, and made with reference to the appended drawings in which:

FIGS. 1 2, 3, 4a and 4b are logic diagrams illustrating the operation of a first embodiment;

FIGS. 5, 6 and 7 are logic diagrams illustrating the operation of a second embodiment; and

FIG. 8 is a logic diagram illustrating an embodiment of a management module of a device.

While the invention is susceptible to various modifications and alternative forms, specific embodiments thereof are shown by way of example in the drawings and will herein be described in detail. It should be understood, however, that the drawing and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

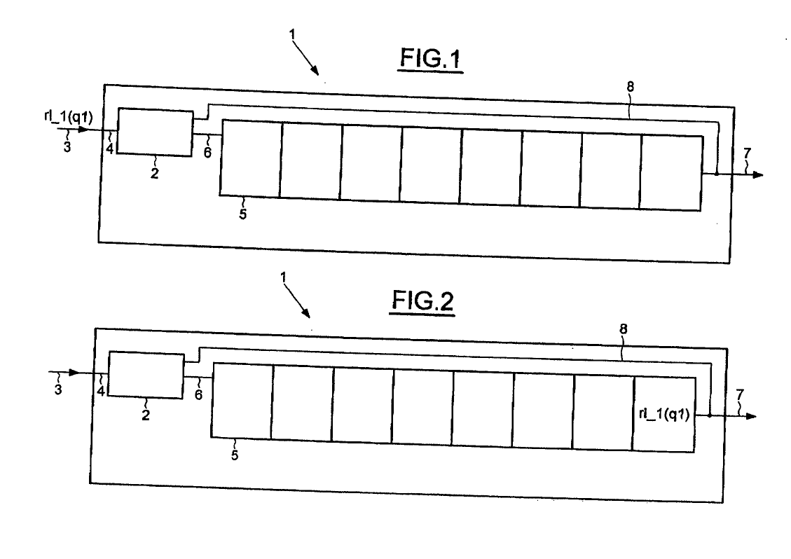

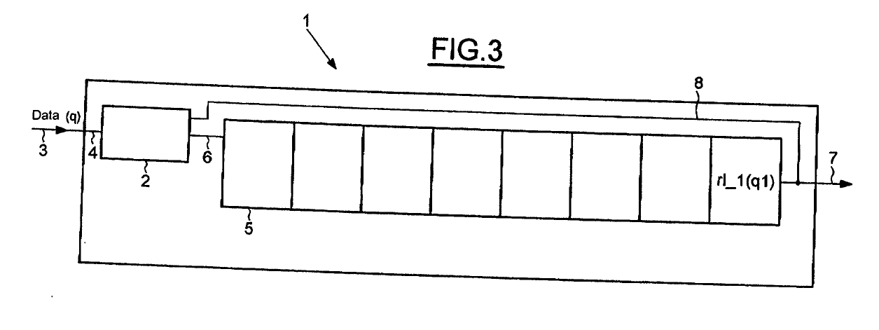

In FIG. 1, the device 1 for memorizing data includes a management module 2 connected to an input 3 of the device 1 via a connection 4, to a memory 5 of the device 1 organized in a queue by a connection 6, and to an output 7 of the device 1 by a connection 8.

In operation, a first read request rl_1 sent by an initiating agent, requesting the reading of a quantity q1 of data in the queue 5 is received at the input 3 by the data memorization device 1. Usually a quantity of data is expressed in bytes. The queue 5 is empty of data and the device 1 cannot therefore satisfy, or serve, the read request rl_1.

The management module 2 then stores the read request rl_1 in the queue 5, as is shown in FIG. 2. The queue 5 is then a read request queue. The conventional devices do not store requests in queues which are data queues only, and return messages to the agent initiating the request or block the system while awaiting data to satisfy the request. This blocks the system or unnecessarily uses bandwidth.

When a quantity q of data arrives at the device, as shown in FIG. 3, several situations may occur.

If the quantity q of data is smaller than the quantity q1 of data required by the read request rl_1 first in the read request queue 5, then the quantity q of data is sent directly by the management module 2 to the output 7, intended for the agent initiating the request rl_1, via the connection 8. The management module 2 also updates the quantity of data required by the read request rl_1 included in the read request rl_1. This is illustrated in FIG. 4a.

FIG. 4b illustrates the situation in which the quantity of data q is greater than or equal to the quantity q1 of data required by the read request rl_1. In this situation, the management module 2 directly transmits the quantity q of data to the output 7, via the connection 8, these data being intended for the agent initiating the read request rl_1. The read request rl_1 is then served, or satisfied, and the management module 2 deletes the read request rl_1 from the queue 5. The queue 5 is then empty, because, in this example, it contained only one read request rl_1. The quantity of data q then being greater than or equal to the quantity q1 of data required by the read request rl_1, the management module 2 memorizes the quantity q-q1 in the empty queue 5, which then becomes a data queue. Naturally, if q=q1, the queue 5 is then empty.

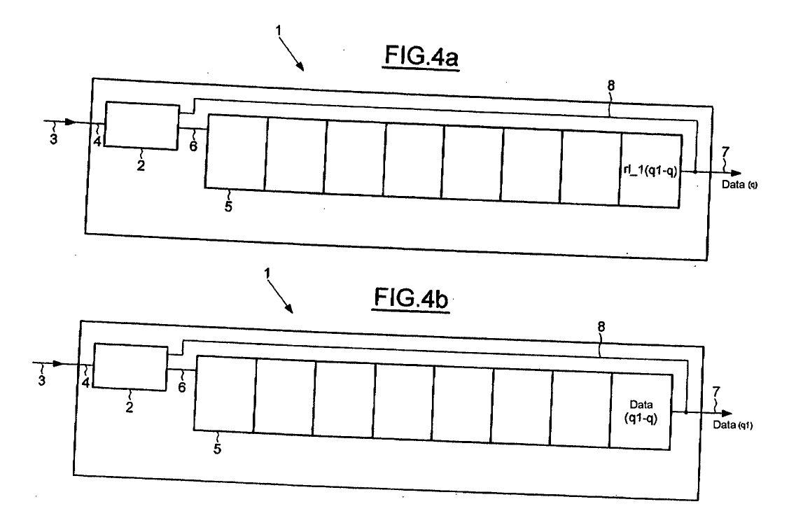

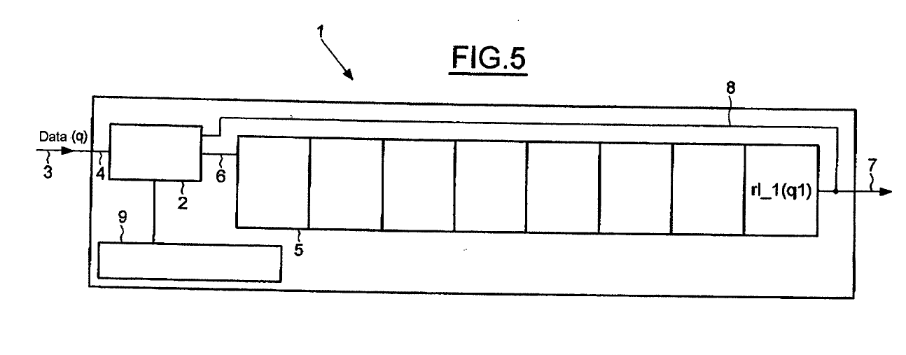

The second embodiment, illustrated by FIG. 5, is similar to the first one shown and also includes an auxiliary memorization module. Operation is the same as that shown by FIGS. 1 and 2, when the queue 5 is initially empty and a read request rl_1 arrives at the input of the device 1. The read request rl_1 has been stored in the queue 5, then a read request queue, and a quantity q of data arrives at the input of the device 1. If the quantity of data q1 required by the read request rl_1 is less than or equal to the quantity q of data, then, as illustrated by FIG. 4b, the read request rl_1 is satisfied directly, without storage of the quantity q1 of first data of the quantity q of data. The request is destroyed and the following data are stored in the then empty queue 5.

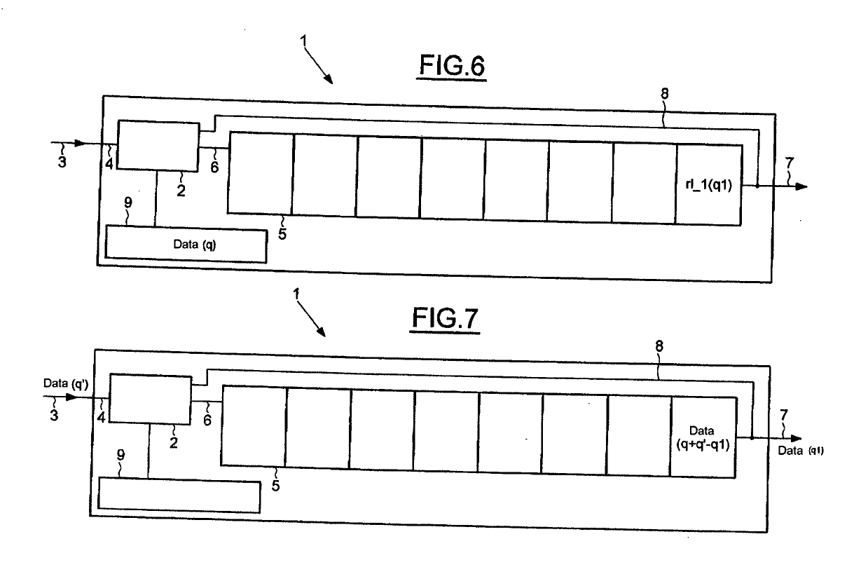

FIG. 6 illustrates the situation in which the quantity q of data is smaller than the quantity q1 of data required by the read request rl_1, the first, and here the only, request of the read request queue 5. The management module 2 then stores the quantity q of data in the auxiliary memorization module 9. The size of this module 9 is designed so that it can at least store the maximum quantity of data that may be requested by a system request.

Then, when a new quantity q′ of data arrives at the input of the data memorization device 1, if the quantity of data q+q′ is less than the quantity q1, then the management module 2 also memorizes in the auxiliary memorization module 9 the quantity q′ of data and the situation is the same as in FIG. 6, except that the quantity of data memorized in the auxiliary memorization module 9 is different.

If a new quantity q′ of data arrives at the input of the data memorization device 1, and the quantity of data q+q′ is greater than or equal to q1, then, as illustrated in FIG. 7, the management module 2 directly transmits the quantity of data q stored in the module 9, and a portion of the quantity of data q′, to the output 7 via the connection 8. The quantity of data transmitted at the output 7 is then q1 and satisfies the read request rl_1, which is then deleted by the management module 2. The queue 5 is then empty, because, in this example, it contained only one read request and data remain that have not been transmitted at the output. The management module 2 then stores the quantity q+q′−q1 of data in the queue.

When the queue 5 is a non-empty data queue, it then operates as a normal queue.

If the queue 5 is a full read request queue, when a read request arrives at the input of the memorization device 1, the management means 2 may return a message to the agent initiating the read request informing it that it must try again later.

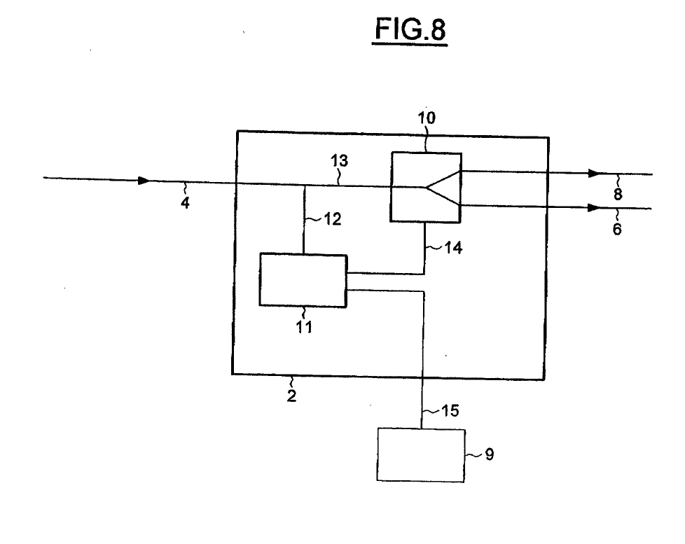

FIG. 8 shows an embodiment of the management module 2. The management module 2 includes a switching module 10 and a decision module 11. The connection 4 is divided into two connections 12 and 13, the connection 12 connecting the decision module 11 and the connection 13 connecting the switching module 10. A connection 14 connects the decision module 11 and the switching module 10. The switching module 10 includes the two outputs 8 and 6, the output 6 being connected to the queue 5 and the output 8 being directly connected to the output 7 of the device 1. An optional connection 15 links the decision module 11 and the optional auxiliary memorization module 9. The decision module 11 is capable of differentiating a request from other data.

When a read request, or a request for other data, arrives via the connection 4 at the management module 2, the decision module 11 handles this information by instructing the switching module 10 to transmit the data or the read request either to the queue 5, or directly to the output 7 of the device 1 via the connection 8.

If the device 1 includes an auxiliary memorization module 9, then the decision module 11 also handles the storage and the destorage of data in this auxiliary memorization module 9.

The elements initiating read requests are not found in a blockage situation, and continue working during the indeterminate time interval separating the moment of transmission of a read request to a target agent and the moment of receipt of the response to the said request.

The embodiments described herein make it possible to avoid unnecessarily blocking an interconnection system or unnecessarily using bandwidth, when a data read request arrives at a memorization device organized as a queue and that queue is empty of data.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description to the invention. Changes may be made in the elements described herein without departing from the spirit and scope of the invention as described in the following claims. In addition, it is to be understood that features described herein independently may, in certain embodiments, be combined.

1. Method of managing a device for memorizing data organized in a queue, wherein, when the said queue is empty of data and the said memorization device receives a data read request, the method comprises memorizing the read request in the queue, instead of the data usually present when the queue is not empty of data, transforming the data queue into a read request queue.

2. Method according to claim 1, wherein, when the queue comprises at least one read request, the receipt of a new read request causes the new read request to be memorized in the read request queue.

3. Method according to claim 1, wherein, when the queue comprises at least one read request, received data is directly transmitted to the agents that have sent the read requests, and the expected quantity of data comprised in the read requests is updated.

4. Method according to claim 1, wherein, when the queue comprises at least one read request, the receipt of a quantity of data smaller than the quantity of data requested by the first read request of the read request queue causes the data to be stored in an auxiliary memorization means, awaiting a later arrival of data to be memorized in the auxiliary memorization means until the quantity of data stored in the auxiliary memorization means is greater than or equal to the quantity of data required by the first read request of the read request queue.

5. Method according to claim 1, wherein, when the queue comprises at least one read request and the first read request of the said request queue is satisfied, the first read request is deleted from the read request queue.

6. Method according to claim 5, wherein, when the read request queue becomes empty of requests and data are received, the data is stored in the empty read request queue which becomes a data queue.

7. Device for memorizing data organized in a queue, wherein the device comprises a management means which, when the queue is empty of data and the device receives a read request, is capable of memorizing the read request in the queue, transforming the queue into a read request queue.

8. Device according to claim 7, wherein the management means is capable of memorizing a newly received read request in the read request queue, when the queue comprises at least one read request.

9. Device according to claim 7, wherein the queue comprises at least one read request, and wherein the management means is capable of transmitting received data directly to the agent that has sent the read request of the queue and of updating the required quantity of data included in the read request.

10. Device according to claim 7, wherein the queue comprises at least one read request, and wherein the device comprises an auxiliary memorization means capable of storing a quantity of received data smaller than the quantity of data required by the read request of the queue.

11. Device according to claim 7, wherein the management means is capable of deleting the read request from the read request queue when the read request of the read request queue is satisfied.
